(19) United States
(12) Patent Application Publication
(10) Pub. No.: US 2026/0260290 A1
(43) Pub. Date: Sep. 3, 2026

(54) SYSTEM AND METHOD FOR LENDER FUNDING NOTIFICATIONS

(71) Applicant: Pyotr Godelman, Sunny Isles Beach, FL (US)

(72) Inventor: Pyotr Godelman, Sunny Isles Beach, FL (US)

(21) Appl. No.: 18/870,836

(22) PCT Filed: Dec. 5, 2023
(86) PCT No.: PCT/US2023/082510

§ 371 Date: Dec. 2, 2024

Related U.S. Application Data
(60) Provisional application No. 63/466,005, filed on May 12, 2023.
(60) Provisional application No. 63/531,613, filed on Aug. 9, 2023.

(51) Int. Cl. G06Q 40/03

(52) U.S. Cl. CPC G06Q 40/0325

(57) ABSTRACT

A loan funding notification system and method that facilitates providing notifications to all transaction parties that a particular loan is in process for remittance to a borrowing party from a particular lending party. A loan transaction associated with a borrowing party and a plurality of lending parties is monitored. This includes the monitoring of various commitment letters that may be issued by a lending party to the borrowing party. A determination is made as to whether the borrowing party has accepted one of the loan commitments for one of the lending parties and whether that borrowing party has also accepted a second loan commitment from a another lending party. Based on this determination, a notification is sent to both lending parties that the borrowing party has accepted a respective loan commitment from each lending party.

### CROSS-REFERENCE TO RELATED APPLICATIONS

This application claims the benefit of U.S. Provisional Patent Application 63/466,005, filed May 12, 2023, and U.S. Provisional Patent Application 63/531,613, filed Aug. 9, 2023, each of which is hereby incorporated by reference herein in its entirety.

### FIELD OF THE INVENTION

The present invention relates generally to financial lending, and more particularly, to a system and method that facilitates providing notifications to all transaction parties that a particular loan is in process for remittance to a borrowing party from multiple lenders.

### BACKGROUND OF THE INVENTION

The financial industry occupies an important position in the economic and social development of society through economic support provided for individuals, industries, companies, and governments. Financial lending institutions may originate loans as well as manage loan repayment and loan default. The loan products offered by the financial lending institutions may include mortgage loans for homes or other real property, auto loans, student loans, and other real or personal property loans.

Borrowers may wish to borrow finances from one or more lenders in order to pay for items, obtain credit for future uses, and/or refinance a previous loan. Borrowers may utilize financial institutions, such as banks, credit companies, or other types of large scale borrowers to obtain such funds. Typically, when a potential borrower seeks a mortgage loan, for example, in purchasing real property, the borrower may opt to consult a number of financial institutions for receiving competitive loan commitments. Such financial institutions may include a primary mortgage lender, such as a bank. In many other cases, borrowers may consult with a third-party originator (“TPO”) or a fulfillment provider, in order to obtain the funds necessary to purchase the property. The TPOs may include brokers, correspondents, non-profit organizations, realtors, professional organizations, affinity groups, credit unions, housing finance agencies, builders, and other trusted advisors. The fulfillment providers may include title search services, flood certification services, credit bureaus, property tax services, payment services, fraud protection services, real estate services, and so on. The lenders, TPOs, and fulfillment providers make loans to borrowers in the “primary mortgage market.” Typically, after a loan is made in the primary mortgage market, the loans may be sold to investors in the “secondary mortgage market.” Given that a potential borrower is typically engaged with multiple lending parties prior to selecting a particular loan commitment it is imperative that once the loan commitment has been accepted between the borrower and the lending party that all the other lending parties involved are notified in order to avoid double funding and to improve overall transaction transparency.

Accordingly, there is need for a technique that facilitates providing notifications to all transaction parties that a particular loan is in process for remittance to a borrowing party from a particular lending party.

### SUMMARY OF THE INVENTION

The present invention is directed to providing a system and method that facilitates providing notifications to all transaction parties that a particular loan is in process for remittance to a borrowing party from a particular lending party.

In a first implementation of the invention, a loan funding notification system is provided that enables notifications to be transmitted to all transaction parties that a particular loan is in process for remittance to a borrowing party from a particular lending party. The loan funding notification system comprising at least: a processor, and a memory storing instructions that when executed cause the processor to perform operations comprising: (i) monitoring at least one loan transaction associated with a borrowing party and a plurality of lending parties; (ii) determining that the borrowing party has accepted a first loan commitment from a first lending party of the plurality of lending parties specific to the at least one loan transaction; (iii) determining that the borrowing party has accepted a second loan commitment from a second lending party of the plurality of lending parties specific to the at least one loan transaction; (iv) notifying the first lending party of the second loan commitment between the second lending party and the borrowing party prior to funding of the first loan commitment by the first lending party; and (v) notifying the second lending party of the first loan commitment between the first lending party and the borrowing party prior to funding of the second loan commitment by the second lending party.

In a second aspect, a method is provided for transmitting notifications to all transaction parties that a particular loan is in process for remittance to a borrowing party from a particular lending party. The method comprising (i) monitoring at least one loan transaction associated with a borrowing party and a plurality of lending parties; (ii) determining that the borrowing party has accepted a first loan commitment from a first lending party of the plurality of lending parties specific to the at least one loan transaction; (iii) determining that the borrowing party has accepted a second loan commitment from a second lending party of the plurality of lending parties specific to the at least one loan transaction; (iv) notifying the first lending party of the second loan commitment between the second lending party and the borrowing party prior to funding of the first loan commitment by the first lending party; and (v) notifying the second lending party of the first loan commitment between the first lending party and the borrowing party prior to funding of the second loan commitment by the second lending party.

In a third aspect, a user device is provided and configured for transmitting notifications to all transaction parties that a particular loan is in process for remittance to a borrowing party from a particular lending party. The user device comprising at least a processor, a display and a memory storing instructions that when executed cause the processor to perform operations comprising (i) monitoring at least one loan transaction associated with a borrowing party and a plurality of lending parties; (ii) determining that the borrowing party has accepted a first loan commitment from a first lending party of the plurality of lending parties specific to the at least one loan transaction; (iii) determining that the borrowing party has accepted a second loan commitment from a second lending party of the plurality of lending parties specific to the at least one loan transaction; (iv) notifying the first lending party of the second loan commitment between the second lending party and the borrowing party prior to funding of the first loan commitment by the first lending party; and (v) notifying the second lending party of the first loan commitment between the first lending party and the borrowing party prior to funding of the second loan commitment by the second lending party.

In a fourth aspect, a loan funding notification application (alternatively referred to herein as an “app”) may be executed on the loan funding notification system and/or the user device for executing the method operations that provide notifications to all transaction parties that a particular loan is in process for remittance to a borrowing party from a particular lending party.

In another aspect, each lending party of the plurality of lending parties is a registered party.

In another aspect, the plurality of loan commitments are stored in a database.

In another aspect, the first lending party and the second party each set at least one term for acceptance of the first loan commitment and the second loan commitment, respectively.

In another aspect, the at least one term comprises an interest rate on a repayment amount, a fee for acceptance and loan disbursement, a repayment structure for the repayment amount, required collateral for acceptance and disbursement, and a payment method to the borrowing party.

In another aspect, at least one requirement in the at least one term is variable based on an acceptable risk tolerance by the first lending party and the second lending party, respectively, and a risk score of the borrowing party.

In another aspect, one of the lending parties is a third-party originator.

In another aspect, the system further comprises a display for presenting the first loan commitment and the second loan commitment to the borrowing party.

In another aspect, responsive to the notifying the second lending party of the first loan commitment between the first lending party and the borrowing party, a loan commitment termination notice is issued by the second lending party.

The methods and systems described herein can be implemented by data processing systems, such as one or more smartphones, tablet computers, desktop computers, laptop computers, smart watches, wearable, audio accessories, on-board computer, and other data processing systems and other consumer electronic devices. The methods and systems described herein can also be implemented by one or more data processing systems which execute executable computer program instructions, stored in one or more non-transitory machine-readable media that cause the one or more data processing systems to perform the one or more methods described herein when the program instructions are executed. Thus, the embodiments described herein can include methods, data processing systems, and non-transitory machine-readable media.

The above summary does not include an exhaustive list of all embodiments in this disclosure. All systems and methods can be practiced from all suitable combinations of the various aspects and embodiments summarized above, and also those disclosed in the detailed description below.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a high-level block diagram of a cloud network services architecture for providing a loan funding notification system in accordance with an embodiment;

FIG. 2 presents a flowchart of illustrative operations for providing loan procurement and funding notifications in accordance with an embodiment;

FIG. 3 presents an illustrative loan funding notification system in accordance with an embodiment;

FIG. 4 presents an illustrative user device configured in accordance with an embodiment;

FIG. 5 presents an illustrative architecture for a loan funding notification app in accordance with an embodiment;

FIG. 6 presents a flowchart of illustrative operations for user onboarding and subscription in accordance with an embodiment; and

FIG. 7 presents an illustrative user device interface resulting from the loan funding procurement and funding notifications operations in accordance with an embodiment.

Like reference numerals refer to like parts throughout the several views of the drawings.

### DETAILED DESCRIPTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

Shown throughout the figures, the present invention is directed toward a loan funding notification system and method that facilitates providing notifications to all transaction parties that a particular loan is in process for remittance to a borrowing party from a particular lending party. That is, in accordance with the principles of the disclosed embodiments, a loan transaction associated with a borrowing party and a plurality of lending parties is monitored. This includes the monitoring of various commitment letters that may be issued by different lending parties to the borrowing party. A determination is made as to whether the borrowing party has accepted one of the loan commitments from one of the lending parties and whether that borrowing party has also accepted a second loan commitment from a another lending party. Based on this determination, a notification is sent to both lending parties that the borrowing party has accepted a respective loan commitment from each lending party. As such, the disclosed embodiments address problems with transparency and fraud detection and prevention in existing loan procurement platforms. It may be also that the different lenders notified might want to work together and restructure their loan commitments depending upon the size of the loan, for example. As result, the loan funding notification system and method of the disclosed embodiments provide an advantageous improvement of practical applications that include on-line and electronic loan procurement platforms and/or financial platforms and loan methodologies.

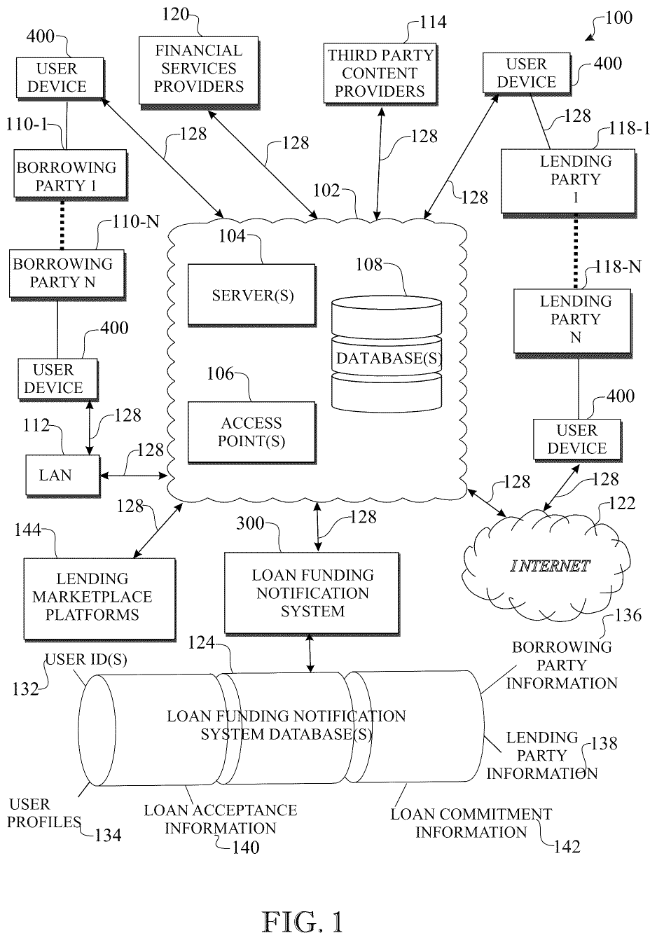

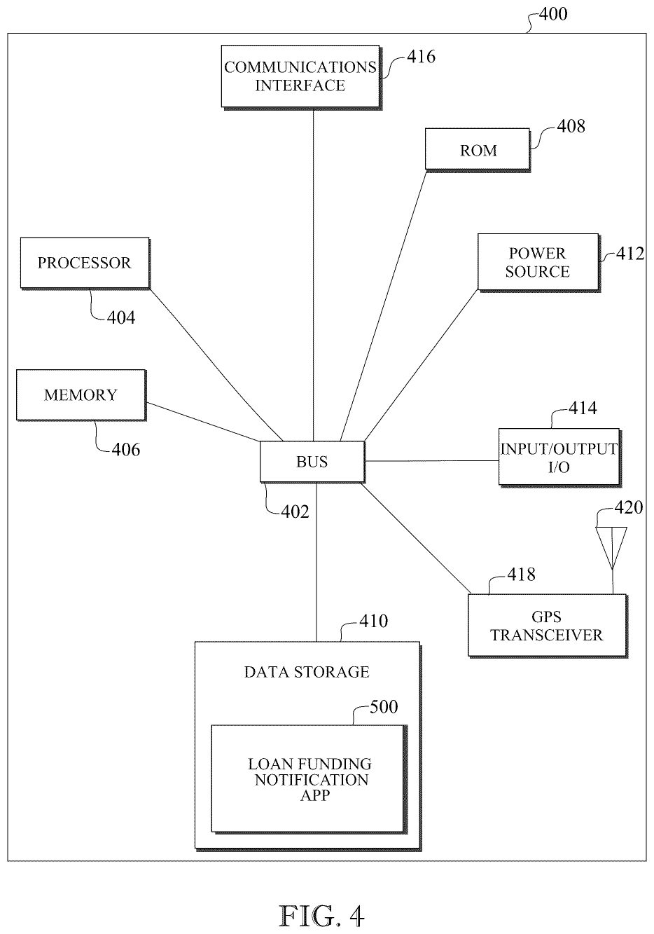

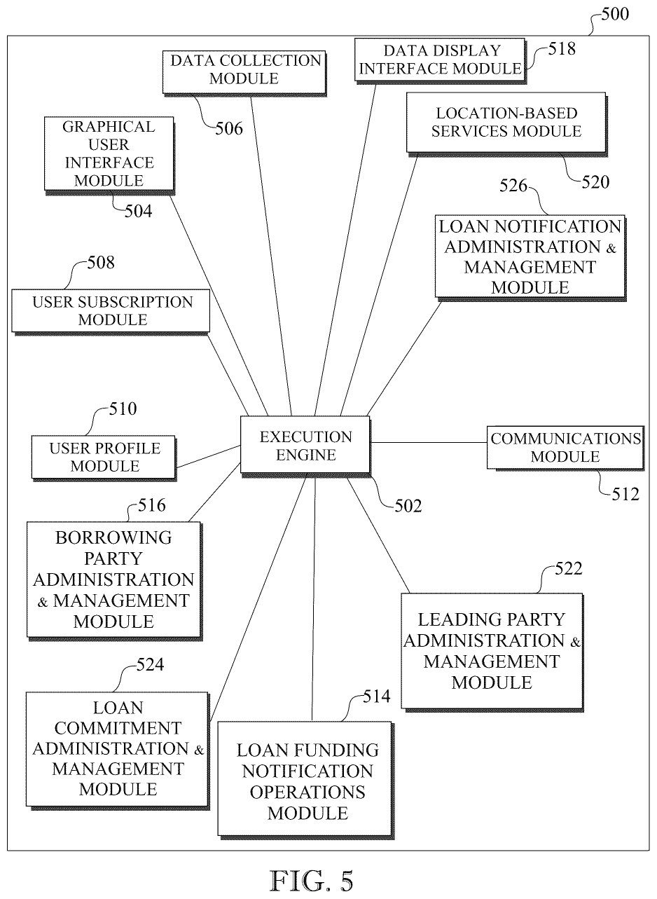

Turning our attention to FIG. 1, a high-level block diagram of a cloud network services architecture 100 is presented for providing loan funding procurement and funding notifications in accordance with the principles of the disclosed embodiments. As will be detailed herein below, the cloud 102 facilitates the delivery of loan funding procurement and funding notifications to a plurality of users (e.g., comprised by borrowing party 1 110-1 through borrowing party N 110-N and/or lending party 1 118-1 through lending party N 118-N) that are offered by and through the loan funding notification system 300 using a loan funding notification app 500, as will be detailed herein below, on user device 400. The user device 400 provides users (e.g., borrowing party 1 110-1 through borrowing party N 110-N) with real-time access to loan funding procurement and funding notifications in accordance with the disclosed embodiments herein. In an embodiment, the loan funding procurement and funding notifications processing, offered by and through the cloud network services architecture 100 and the loan funding notification system 300 will be facilitated by the loan funding notification app 500 (see, FIG. 5), as will be detailed herein below, executing on the user device 400 (see, FIG. 4).

As noted above, the cloud 102 comprises at least server(s) 104, the access point(s) 106 and the database(s) 108. Cloud, cloud service, cloud server and cloud database are broad terms and are to be given their ordinary and customary meaning to one of ordinary skill in the art and includes, without limitation, any database, data repository or storage media which store content typically associated with and managed by a user, banks, financial service providers (e.g., financial services providers 120), lending marketplace platforms (e.g., lending marketplace platforms 144) and third-party content providers (e.g., third-party content providers 114) in the context of loan funding procurement and funding notifications services, to name just a few. A cloud service may include one or more cloud servers and cloud databases that provides for the remote storage of content as hosted by a third-party service provider or operator. A cloud server may include an HTTP/HTTPS server sending and receiving messages in order to provide web-browsing interfaces to client web browsers as well as web services to send data to integrate with other interfaces (e.g., as executed on the user device 400). The cloud server may be implemented in one or more servers and may send and receive content in a various forms and formats, user supplied and/or created information/content and profile/configuration data that may be transferred from or stored in a cloud database (e.g., the databases 108).

The term “cloud computing” as referred to herein implies the on-demand availability of computer system resources, especially data storage and computing power, without direct active management by the user. The term is generally used to describe data centers available to many users over the Internet. Large clouds, predominant today, often have functions distributed over multiple locations from central servers. If the connection to the user is relatively close, it may be designated an edge server. Clouds may be limited to a single organization (e.g., enterprise clouds), be available to many organizations (e.g., public cloud), or a combination of both (e.g., hybrid cloud). A cloud database may include one or more physical servers, databases or storage devices as dictated by the cloud service's storage requirements. The cloud database may further include one or more well-known databases (e.g., an SQL database) or a fixed content storage system to store content, user profile information, configuration information, administration information and any other information necessary to execute the cloud service. In various embodiments, one or more networks providing computing infrastructure on behalf of one or more users may be referred to as a cloud, and resources may include, without limitation, data center resources, applications (e.g., software-as-a-service or platform-as-a-service) and management tools.

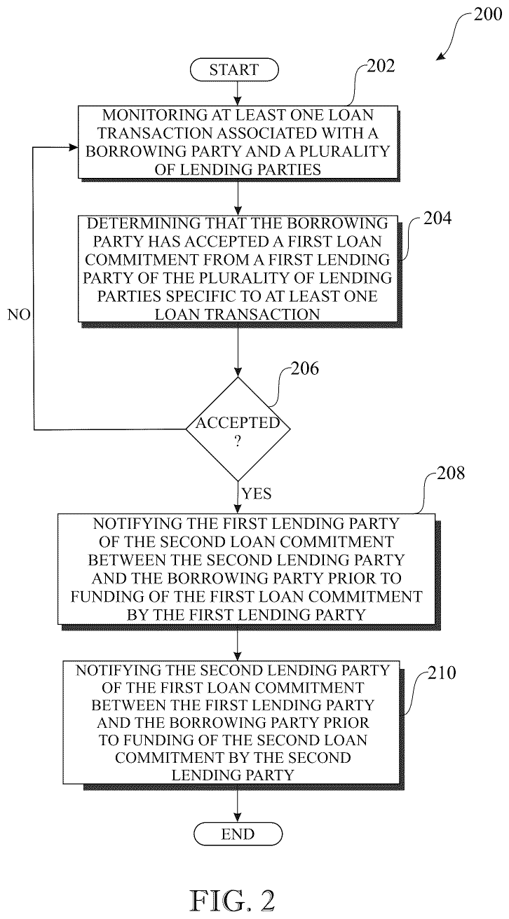

Turning our attention to FIG. 2, a flowchart of illustrative operations 200 are shown for providing loan procurement and funding notifications in accordance with an embodiment. More particularly, at step 202, monitoring at least one loan transaction associated with a borrowing party and a plurality of lending parties. Illustratively, the monitored loan transaction includes, but is not limited to, loan procurement and the issuance of loan commitments between lending parties and a particular borrowing party. That is, typically a borrowing party will seek competitive quotes for their financial loan needs. A lender will issue a so-called loan commitment letter which is a formal document from the lender stating that the borrowing party is approved for the loan. Lenders issue a loan commitment letter after the borrowing party successfully completes the preapproval process and loan requirements required by the lending party. The commitment letter is a formal, legal and binding document that is issued to a loan applicant (i.e., the borrowing party) by a lender. The letter's content states that the lender is going to extend a loan to the applicant and what the precise terms and conditions of the loan are including the rate of interest. At steps 204 and 206, determining that the borrowing party has accepted a first loan commitment from a first lending party of the plurality of lending parties specific to the at least one loan transaction and also determining that the borrowing party has accepted a second loan commitment from a second lending party of the plurality of lending parties specific to the at least one loan transaction. In this way, transparency with respect to the loan transaction is increased and fraud detection and prevention is heightened. Further, the lenders notified might want to work together and restructure their loan commitments depending upon the size of the loan, for example, so that each may participate in the final loan transaction. Then, at step 208, notifying the first lending party of the second loan commitment between the second lending party and the borrowing party prior to funding of the first loan commitment by the first lending party and step 210, notifying the second lending party of the first loan commitment between the first lending party and the borrowing party prior to funding of the second loan commitment by the second lending party.

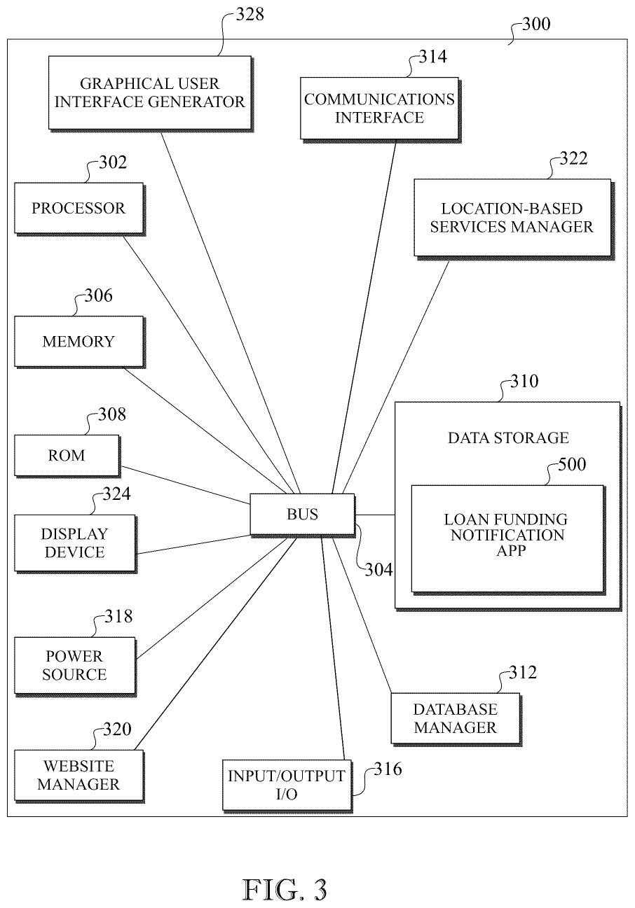

Turning our attention to FIG. 3, an illustrative configuration for the loan funding notification system 300 is shown for deployment in the cloud network services architecture 100 in accordance with an embodiment. As shown, the loan funding notification system 300 comprises processor 302 for executing program code (e.g., loan funding notification app 500) and communications interface 314 for managing communications to and from the loan funding notification system 300, memory 306, data storage 310, and/or read-only memory (ROM) 308 for storing program code and data, and power source 318 for powering the loan funding notification system 300. The memory 306 is coupled to the bus 304 for storing computer-readable instructions to be executed by the processor 302 (e.g., execution of the loan funding notification app 500). Database manager 312 is used to manage the delivery and storage of content, data, and other information in the loan funding notification system database(s) 124, database(s) 108 and across third-party content providers, for example. The loan funding notification system database(s) 124 may store and provide information including, but not limited, to user IDs 132, user profiles 134, borrowing party information 136, lending party information 138, loan acceptance information 140, and loan commitment information 142. As detailed herein, the operations performed by for the loan funding notification system 300 in combination with the loan funding notification app 500, for example, provide for the loan procurement and funding notifications.

Website manager 320 is used to deliver and manage content, data, and other information across one or more websites that may be utilized to access and use the loan funding notification system 300, for example. Further, the operations provided by and through the loan funding notification app 500 may be offered through a web-based application. As will be discussed in greater detail herein below, the loan funding notification app 500, as stored in data storage 310, when executed by the processor 302 will enable access by a plurality of users (e.g., borrowing party 1 110-1 through borrowing party N 110-N and/or lending party 1 118-1 through lending party N 118-N) to the loan funding notification system 300 for the processing of, for example, the user IDs 132, user profiles 134, borrowing party information 136, lending party information 138, loan acceptance information 140, and loan commitment information 142. Location-based services manager 322 facilitates the delivery of location-based services (e.g., Global Positioning System (GPS) tracking) either independently or on user device 400. This allows the loan funding notification system 300 to register the exact location of the user of the user device 400, for example, as the borrowing party 1 110-1 roams from one location to another location such that the services offered via the loan funding procurement and funding notifications processing hereunder may be tailored to a current location and/or the needs of the borrowing party 1 110-1, for example, as they may change based on their current location which may influence their selection of one of the loan commitment letters when presented thereto, for example.

In an embodiment, the loan funding procurement and funding notifications processing provided through the execution of the loan funding notification app 500 may also include a web-based delivery platform and/or accessing and interfacing any number of websites using website manager 320 for procuring information and data that can be used in the loan funding notification system 300. The term “website” in the context herein is used in a conventional and broadest sense and is located on at least one server containing web pages stored thereon and is operational in a 24-hour/7-day typical fashion. Further, as shown in the cloud network services architecture 100, the plurality of users (i.e., borrowing party 1 110 through borrowing party N 110-N and/or lending party 1 118-1 through lending party N 118-N) may alternatively utilize well-known Internet 122 for access to loan funding notification system 300 by and through a web browser on the user device 400, for example. The loan funding notification system 300 may also include one or more input/output devices 316 that enable user interaction with the user device 400 (e.g., camera, display, keyboard, mouse, speakers, microphone, buttons, etc.). The input/output devices may include peripherals, such as an NFC device (e.g., NFC tag reader), camera, printer, scanner (e.g., a QR-code scanner), touchscreen display, etc. For example, the input/output devices 316 may include a display device such as a cathode ray tube (CRT), plasma monitor, liquid crystal display (LCD) monitor or organic light-emitting diode (OLED) monitor for displaying information to the user, a keyboard, and a pointing device such as a mouse or a trackball by which the user can provide input to the user device 400 or an associated display device 324, for example, that may also be managed by graphical user interface generator 328.

The communications interface 314 is used to facilitate communications across the communications links 128 (see, FIG. 1) within the cloud network services architecture 100. This may take the form, for example, of a wide area network connection that communicatively couples the loan funding notification system 300 with the access points 106 (see, FIG. 1) which may be a cellular communications service. Similarly, communications managed by the communications interface 314 may take the form, for example, of a local Wi-Fi network interface or Ethernet interface the communicatively couples the loan funding notification system 300 with the Internet 122, local area network (LAN) 112, and ultimately the user device 400. In the instant embodiment, the loan funding notification app 500 and/or the communications interface 314 may include a communications stack for facilitating communications over the respective communications link 128. Electronic communications by and through loan funding notification system 300 between the various systems, networks, devices, users, entities, and/or individuals are facilitated by the communications links 128 in accordance with any number of well-known communications protocols and methods (e.g., wireless communications).

Turning our attention briefly to FIG. 4, an illustrative user device 400 is shown configured in accordance with an embodiment. The user device 400 typically includes bus 402 and processor 404 coupled to the bus 402 for executing operations and processing information. As will be appreciated, a “user device” in the context herein may comprise a wide variety of devices such as any type of hardware device, mobile devices, smartphones, laptop computers, desktop computers, tablets, and wearable devices, to name just a few, that execute applications (e.g., a mobile application) in accordance with the principles of the disclosed embodiments herein. For example, the execution of the loan funding notification app 500 will be discussed in much greater detail herein below. The processor 404, as powered by power source 412, may include both general and special purpose microprocessors, and may be the sole processor or one of multiple processors of the device. This is equally applicable to the processor 302 of FIG. 3. Further, the processor 404 (or the processor 302) may comprise one or more central processing units (CPUs) and may include, be supplemented by, or incorporated in, one or more application-specific integrated circuits (ASICs) and/or one or more field programmable gate arrays (FPGAs).

The user device 400 may also include memory 406 coupled to the bus 402 for storing computer-readable instructions to be executed by the processor 404. The memory 406 may also be utilized for storing temporary variables or other intermediate information during the execution of the instructions by the processor 404. The user device 400 may also include ROM 408 or other static storage device coupled to the bus 402. Further, data storage device 410, such as a magnetic, optical, or solid-state device may be coupled to the bus 402 for storing information and instructions for the processor 404 including, but not limited to, the loan funding notification app 500. Data storage device 410 (or the data storage device 310) and the memory 406 (and the memory 306) may each comprise a non-transitory computer readable storage medium and may each include high-speed random access memory, such as dynamic random access memory (DRAM), static random access memory (SRAM), double data rate synchronous dynamic random access memory (DDR RAM), or other random access solid state memory devices, and may include non-volatile memory, such as one or more magnetic disk storage devices such as internal hard disks and removable disks, magneto-optical disk storage devices, optical disk storage devices, flash memory devices, semiconductor memory devices, such as erasable programmable read-only memory (EPROM), electrically erasable programmable read-only memory (EEPROM), compact disc read-only memory (CD-ROM), digital versatile disc read-only memory (DVD-ROM) disks, or other non-volatile solid state storage devices.

The user device 400 may also include one or more communications interface 416 for communicating with other devices via a network (e.g., a wireless communications network) or communications protocol (e.g., Bluetooth®). For example, such communications interfaces may be a receiver, transceiver, or modem for exchanging wired or wireless communications in any number of well-known fashions. For example, the communications interface 416 (or the communications interface 314) may be an integrated services digital network (ISDN) card or modem/router used to facilitate data communications of various well-known types and formats. Further, illustratively, the communications interface 416 (or the communications interface 314) may be a LAN card used to provide data communication connectivity to a comparable LAN. Wireless communication links may also be implemented. The GPS transceiver 418 and antenna 420 facilitate delivery of location-based services in order to register the exact location of the user device 400, for example, as the user roams from one location to another location. As will be understood, the application herein will be able to track individual users and their location (and proximities to other locations) upon the launching of the application thereby enabling the well understood GPS location features of the user device 400 (e.g., a smartphone).

As will be appreciated, the functionality of the communications interface 416 (or the communications interface 314) is to send and receive a variety of signals (e.g., electrical, optical, or other signals) that transmit data streams representing various data types. The user device 400 may also include one or more input/output devices 414 that enable user interaction with the user device 400 such as a camera, display, keyboard, mouse, speakers, microphone, buttons, etc. The input/output devices 414 (or I/O devices 316) may include peripherals, such as an NFC device (e.g., NFC reader), camera, printer, scanner (e.g., QR-code scanner), touchscreen display, etc. For example, the input/output devices 414 (or the I/O devices 316) may include a display device such as a cathode ray tube (CRT), plasma monitor, liquid crystal display (LCD) monitor or organic light-emitting diode (OLED) monitor for displaying information to the user, a keyboard, and a pointing device such as a mouse or a trackball by which the user can provide input to the user device 400 or an associated display device, for example.

Turning our attention to FIG. 5, an illustrative architecture for the operation of the loan funding notification app 500 is presented in accordance with an embodiment. As will be appreciated, the architecture may be used, illustratively, in conjunction with the cloud network services architecture 100, the loan funding notification system 300, and/or the user device 400 for launching and executing the loan funding notification app 500 and its associated operations. As shown, the architecture for the operations of the loan funding notification app 500 provides several interfaces and engines used to perform a variety of functions such as the collection, aggregation, manipulation, processing, analyzing, verification, authentication, and display of applicable real-time information and data that are useful to realize the delivery of the loan procurement and funding notifications operations of the disclosed embodiments. More particularly, data display interface module 518 and communications module 512 are used to facilitate the input/output and display of electronic data and other information to, illustratively, the users (e.g., borrowing party 1 110-1 through borrowing party N 110-N) employing the user device 400 (e.g., a touch screen of the user device 400) and executing the loan funding notification app 500. The data collection module 506 facilitates data gathering from the plurality of users and other third parties. The location-based services module 520 provides for the delivery of location-based services in order for the geographic locations of the users to be identified and displayed (e.g., GPS locations). The communications module 512 will also facilitate communications by and through the loan funding notification system 300, for example.

Execution engine 502 may be employed to deliver the loan funding procurement and funding notifications herein through the execution of the loan funding notification app 500. In such delivery, the execution engine 502 will operate and execute, as further detailed herein below, with at least the following program modules: graphical user interface module 504, data collection module 506, user subscription module 508, user profile module 510, communications module 512, loan funding notification operations module 514, borrowing party administration and management module 516, lending party administration and management module 522, loan commitment administration and management module 524, and loan notification administration and management module 526. The user subscription module 508 provides for the delivery and management of a subscription-based loan funding procurement and funding notifications model whereby individual users (e.g., borrowing party 1 110-1 through borrowing party N 110-N) subscribe in order to access the loan funding procurement and funding notifications through execution of the loan funding notification app 500 and engaging in their loan activities. In an embodiment, the user may initially subscribe, as facilitated by the user subscription module 508 for a defined fee in a tier subscription system such that users who pay more for their access subscription are provided priority and other advantages over other users in lower tiers or who are subscribed through a base “no fee” trial plan (e.g., a free 30 day trial period). Illustratively, a user paying the subscription fee will be able to access a wider variety of financial institutions or have the ability to be presented with a more diverse selection of loan terms and more favorable interest rates. The user subscription module 508 will also provide for the creation and maintenance of individual user profiles for each subscribed user in conjunction with the user profile module 510 that will manage and administer such user profiles. Further, in an embodiment, the graphical user interface module 504, data display interface module 518, and the communications module 512 are used to facilitate the input/output and display of electronic data and other information (e.g., a graphical user interface) to, illustratively, the users (e.g., borrowing party 1 110-1 through borrowing party N 110-N) employing the user device 400 (e.g., a touch screen) and executing the loan funding notification app 500. The data collection module 506 facilitates loan funding procurement and funding notifications information collection from the plurality of users (i.e., borrowing party 1 110-1 through borrowing party N 110-N) such as loan application information. The data collection module 506 may also be used to collect a variety of loan funding procurement and funding notifications information from other virtual and/or electronic sources accessible via the Internet 122 and individual third party websites hosted thereon. The operations executed by each and every of the foregoing modules are, for example, as discussed throughout this disclosure.

Those skilled in the art will appreciate that the present disclosure contemplates the use of systems configurations and/or computer instructions that may perform any or all of the operations involved in the loan funding procurement and funding notifications herein. The disclosure of computer instructions that include, for example, the loan funding notification app 500 and the loan funding notification system 300 instructions is not meant to be limiting in any way. Those skilled in the art will readily appreciate that stored computer instructions and/or systems configurations may be configured in any way while still accomplishing the various goals, features, and advantages according to the present disclosure. The terms “program,” “application,” “software application,” and the like as used herein, are defined as a sequence of instructions designed for execution on a computer system. A “program,” “computer program,” “application,” or “software application” may include a subroutine, a function, a procedure, an object method, an object implementation, an executable application, an applet, a servlet, a source code, an object code, a shared library/dynamic load library, and/or other sequence of instructions designed for execution on a computer system. Accordingly, the loan funding notification app 500, for example, may be written using any number of programming languages and/or executed on compatible platforms including, but not limited to, JavaScript, PHP (PHP: Hypertext Preprocessor), WordPress, Drupal, Laravel, React.js, Angular.js, and Vue.js. Computer readable program instructions for carrying out operations of the disclosed embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on one or more standalone computers, partly on one or more standalone computers, as a stand-alone software package, partly on one or more standalone computers and partly on one or more remote computers, partly on one or more standalone computers and partly on one or more distributed computing environments (such as a cloud environment), partly on one or more remote computers and partly on one or more distributed computing environments, entirely on one or more remote computers or servers, or entirely on one or more distributed computing environments. Standalone computers, remote computers, and distributed computing environments may be connected to each other through any type of network or combination of networks, including local area networks (LANs), wide area networks (WANs), through the Internet (e.g., using an Internet Service Provider), or the connection may be made to external computers.

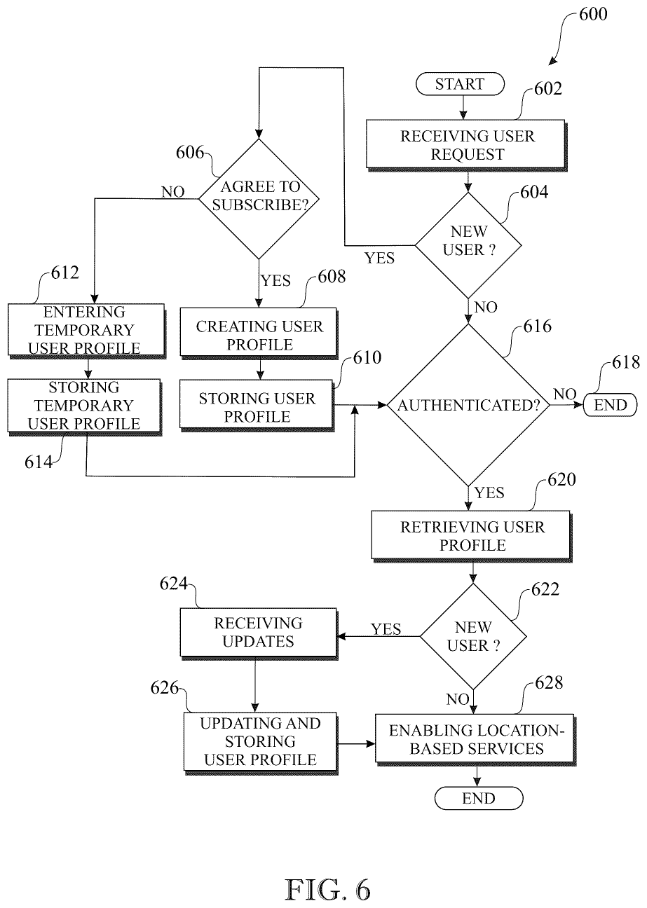

Turning our attention to FIG. 6, a flowchart of illustrative operations 600 is shown for user onboarding and subscription in accordance with an embodiment. As noted above, the disclosed embodiments herein contemplate a subscription-based service for use by the users but may also be used in a no-fee or non-subscribed platform. As such, at step 602, receiving a user request (e.g., the borrowing party 1 110-1 or the lending party 1 118-1). At step 604, determining if a user is a new or returning user and, if a new user, then at step 606 determining whether the user is a subscriber or not (e.g., in accordance with a user agreement and/or user privacy/security agreement). If so, then the new user is subscribed and, at step 608, a user profile is created and the user profile is stored, at step 610. In accordance with the principles of the embodiments hereunder, the user profile may comprise, among other information, at least the user's name, contact address, social security number or other unique identifier, a user ID, payment information, and other associated information. If the user declines to become a subscriber, then they may proceed as a non-subscriber user and will be entering, at step 612, a temporary user profile and storing the user profile at step 614. Illustratively, such temporary user profile may be an abbreviated version of the aforementioned subscriber's user profile. If the user is a returning user (or one of the newly users or new non-subscribed user), their identity is authenticated, at step 616 (e.g., using the aforementioned user ID 132). In an embodiment, two-factor authentication is used to verify the user's credentials (e.g., a text message to the user device 400 associated with this user). If not authenticated, then the operations end at step 618, and if they are authenticated then, at step 620, their respective user profile is retrieved. A determination is made, at step 622, as to whether any updates to the user profile are desired and if so, then at step 624, receiving the update, and updating and storing the user profile, at step 626. If no updates are necessary (or after the updating operations are completed), at step 628, there is an enablement of location-based services (e.g., on the user device 400 associated with the user, for example, the borrowing party 1 110-1) to facilitate the location-based services operations detailed herein.

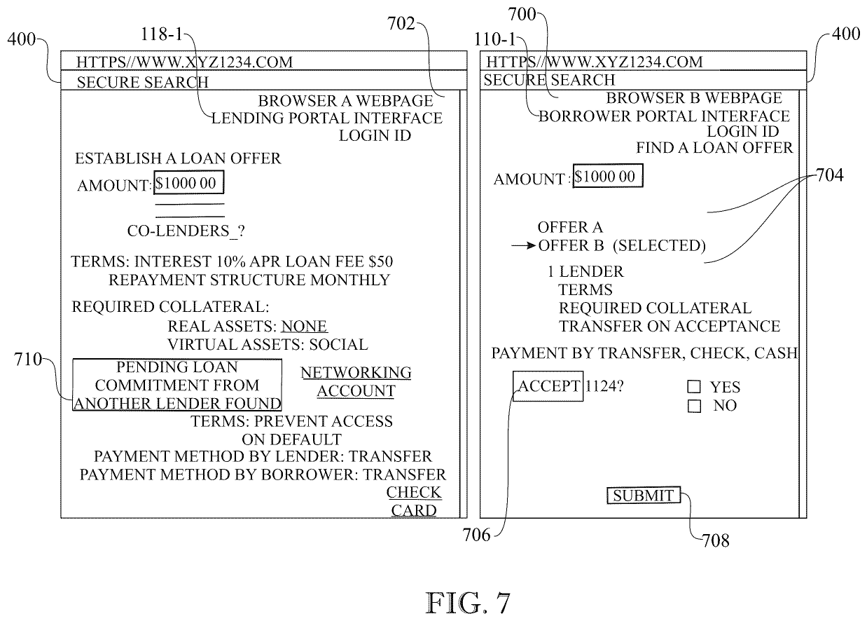

Turning our attention to FIG. 7, an illustrative user device interface is presented resulting from the loan funding procurement and funding notifications operations in accordance with an embodiment. More particularly, FIG. 7 shows an exemplary graphical user interface (GUI) 700 (illustratively, a mobile user interface, as displayed by and through the user device 400), to a borrowing party (e.g., borrowing party 1 110-1), and graphical user interface 702 for a lending party (e.g., lending party 1 118-1) on their user device 400. The borrowing party is in the process of pursuing a loan commitment from a plurality of lending parties 704. The borrowing party may indicate their acceptance of one of the loan commitments provided using icon 706 and transmit such acceptance via icon 708. As detailed above, this will trigger a notification 710 transmission to the user device 400 associated with the lending party that will notify this lending party that the borrowing party has accepted a loan commitment from another lender. Thus, this lending party may decide how they want to proceed with the borrowing party given this received notification.

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention. A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices. “Software” may refer to prescribed rules to operate a computer. Examples of software may include code segments in one or more computer-readable languages; graphical and or/textual instructions; applets; pre-compiled code; interpreted code; compiled code; and computer programs. A network is a collection of links and nodes (e.g., multiple computers and/or other devices connected together) arranged so that information may be passed from one part of the network to another over multiple links and through various nodes. Examples of networks include the Internet, the public switched telephone network, wireless communications networks, computer networks (e.g., an intranet, an extranet, a local-area network, or a wide-area network), wired networks, and wireless networks.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium pro-duce an article of manufacture including instructions which implement the function/act specified in the flowchart and/or block diagram block or blocks. Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media. When a single device or article is described herein, it will be readily apparent that more than one device/article (whether or not they cooperate) may be used in place of single device/article. Similarly, where more than one device or article is described herein (whether or not they cooperate), it will be readily apparent that a single device/article may be used in place of the more than one device or article. The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-transitory, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, a RAM, a PROM, an EPROM, a FLASH-EEPROM, removable media, flash memory, a “memory stick”, any other memory chip or cartridge, a carrier wave as described hereinafter, or any other medium from which a computer can read. Various forms of computer readable media may be involved in carrying sequences of instructions to a processor. For example, sequences of instruction may be delivered from RAM to a processor, may be carried over a wireless transmission medium, and/or may be formatted according to numerous formats, standards or protocols, such as Bluetooth, 4G, 5G, etc.

Where databases are described, it will be understood by one of ordinary skill in the art that alternative database structures to those described may be readily employed, and other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units. A “network” may refer to a number of computers and associated devices that may be connected by communication facilities. A network may involve permanent connections such as cables or temporary connections such as those made through the telephone or other communication links. A network may further include hard-wired connections (e.g., coaxial cable, twisted pair, optical fiber, waveguides, etc.) and/or wireless connections (e.g., radio frequency waveforms, free space optical waveforms, acoustic waveforms, etc.). Examples of a network may include: an internet, such as the Internet; an intranet; a LAN; a wide area network (WAN); and a combination of networks, such as an internet and an intranet.

As noted above, in some embodiments the method or methods described above may be executed or carried out by a computing system including a non-transitory computer-readable storage medium, also described herein as a storage machine, that holds machine-readable instructions executable by a logic machine (i.e., a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be configured to execute instructions to perform tasks for a computer program. The logic machine may include one or more processors to execute the machine-readable instructions. The computing system may include a display subsystem to display a graphical user interface (GUI), or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be configured to connect to and receive input from devices such as a mouse, keyboard, or gaming controller. For example, a user input may indicate a request that certain task is to be executed by the computing system, such as requesting the computing system to display any of the above-described information or requesting that the user input updates or modifies existing stored information for processing. A communication subsystem may allow the methods described above to be executed or provided over a computer network. For example, the communication subsystem may be configured to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Thus, the steps of the disclosed method(s) and the associated discussion herein above can be defined by the computer program instructions stored in a memory and/or data storage device and controlled by a processor executing the computer program instructions. Accordingly, by executing the computer program instructions, the processor executes an algorithm defined by the disclosed method. For example, the computer program instructions can be implemented as computer executable code programmed by one skilled in the art to perform the illustrative operations defined by the disclosed methods. Further, it will be appreciated that any flowcharts, flow diagrams, state transition diagrams, pseudo code, program code and the like represent various processes which may be substantially represented in computer readable medium and so executed by a computer, machine, or processor, whether or not such computer, machine or processor is explicitly shown. One skilled in the art will recognize that an implementation of an actual computer or computer system may have other structures and may contain other components as well, and that a high level representation of some of the components of such a computer is for illustrative purposes.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A loan funding notification system comprising:
a processor;
a memory storing instructions that when executed cause the processor to perform operations comprising:
monitoring at least one loan transaction associated with a borrowing party and a plurality of lending parties;
determining that the borrowing party has accepted a first loan commitment from a first lending party of the plurality of lending parties specific to the at least one loan transaction;
determining that the borrowing party has accepted a second loan commitment from a second lending party of the plurality of lending parties specific to the at least one loan transaction;
notifying the first lending party of the second loan commitment between the second lending party and the borrowing party prior to funding of the first loan commitment by the first lending party; and
notifying the second lending party of the first loan commitment between the first lending party and the borrowing party prior to funding of the second loan commitment by the second lending party.

2. The loan funding notification system of claim 1, wherein the operations performed by the processor further comprise:
registering each lending party of the plurality of lending parties.

3. The loan funding notification system of claim 1, wherein the operations performed by the processor further comprise:
storing a plurality of loan commitments in a database.

4. The loan funding notification system of claim 1, wherein the first lending party and the second party each set at least one term for acceptance of the first loan commitment and the second loan commitment, respectively.

5. The loan funding notification system of claim 4, wherein the at least one term comprises an interest rate on a repayment amount, a fee for acceptance and loan disbursement, a repayment structure for the repayment amount, required collateral for acceptance and disbursement, and a payment method to the borrowing party.

6. The loan funding notification system of claim 5, wherein at least one requirement in the at least one term is variable based on an acceptable risk tolerance by the first lending party and the second lending party, respectively, and a risk score of the borrowing party.

7. The loan funding notification system of claim 1, wherein the first lending party is a third-party originator.

8. The loan funding notification system of claim 1, wherein the loan funding notification system further comprises:
a display for presenting the first loan commitment and the second loan commitment to the borrowing party.

9. The loan funding notification system of claim 1, wherein the operations performed by the processor further comprise:
presenting, on the display, the first loan commitment and the second loan commitment to the borrowing party.

10. The loan funding notification system of claim 1, wherein the operations performed by the processor further comprise:
responsive to the notifying the second lending party of the first loan commitment between the first lending party and the borrowing party, receiving a loan commitment termination notice from the second lending party; and
transmitting the loan commitment termination notice to the borrowing party.

11. A loan funding notification system comprising:
a processor;
a memory storing instructions that when executed cause the processor to perform operations comprising:
registering a plurality of lending parties;
monitoring at least one loan transaction associated with a borrowing party and particular ones of the plurality of lending parties registered;
determining that the borrowing party has accepted a first loan commitment from a first lending party of the plurality of lending parties specific to the at least one loan transaction;
determining that the borrowing party has accepted a second loan commitment from a second lending party of the plurality of lending parties specific to the at least one loan transaction, wherein the first lending party and the second party each set at least one term for acceptance of the first loan commitment and the second loan commitment, respectively;
notifying the first lending party of the second loan commitment between the second lending party and the borrowing party prior to funding of the first loan commitment by the first lending party; and
notifying the second lending party of the first loan commitment between the first lending party and the borrowing party prior to funding of the second loan commitment by the second lending party.

12. The loan funding notification system of claim 11, wherein the operations performed by the processor further comprise:
receiving a selection of the first lending party and the second lending party from the borrowing party.

13. The loan funding notification system of claim 11, wherein the at least one term comprises an interest rate on a repayment amount, a fee for acceptance and loan disbursement, a repayment structure for the repayment amount, required collateral for acceptance and disbursement, and a payment method to the borrowing party.

14. The loan funding notification system of claim 11, wherein the operations performed by the processor further comprise:
responsive to the notifying the second lending party of the first loan commitment between the first lending party and the borrowing party, receiving a loan commitment termination notice from the second lending party; and
transmitting the loan commitment termination notice to the borrowing party.

15. The loan funding notification system of claim 11, wherein the loan funding notification system further comprises:
a display for presenting the first loan commitment and the second loan commitment to the borrowing party.

16. A non-transitory computer readable medium having executable code stored thereon, that when executed, cause a computing device to perform operations comprising:
monitoring at least one loan transaction associated with a borrowing party and a plurality of lending parties;
determining that the borrowing party has accepted a first loan commitment from a first lending party of the plurality of lending parties specific to the at least one loan transaction;
determining that the borrowing party has accepted a second loan commitment from a second lending party of the plurality of lending parties specific to the at least one loan transaction;
notifying the first lending party of the second loan commitment between the second lending party and the borrowing party prior to funding of the first loan commitment by the first lending party;
notifying the second lending party of the first loan commitment between the first lending party and the borrowing party prior to funding of the second loan commitment by the second lending party;
responsive to the notifying the second lending party of the first loan commitment between the first lending party and the borrowing party, receiving a loan commitment termination notice from the second lending party; and
transmitting the loan commitment termination notice to the borrowing party.

17. The non-transitory computer readable medium of claim 16, wherein the operations performed by the computing device further comprise:
receiving at least one term for acceptance of the first loan commitment from the first lending party and the second loan commitment from the second party, respectively.

18. The non-transitory computer readable medium of claim 17, wherein the at least one term comprises an interest rate on a repayment amount, a fee for acceptance and loan disbursement, a repayment structure for the repayment amount, required collateral for acceptance and disbursement, and a payment method to the borrowing party.

19. The non-transitory computer readable medium of claim 16, wherein the operations performed by the computing device further comprise:
registering each lending party of the plurality of lending parties.

20. The non-transitory computer readable medium of claim 16 wherein the operations performed by the computing device further comprise:
receiving a selection of the first lending party and the second lending party from the borrowing party.
